(19) United States
(12) Patent Application Publication
(10) Pub. No.: US 2023/0273314 A1
(43) Pub. Date: Aug. 31, 2023

(54) MULTI-TONE COHERENT LIGHT DETECTION AND RANGING

(71) Applicant: Lumentum Operations LLC, San Jose, CA (US)

(72) Inventors: Stefano BOTTACCHI, Milano (IT); Dan TAUBER, Mountain View, CA (US)

(21) Appl. No.: 17/661,134

(22) Filed: Apr. 28, 2022

Related U.S. Application Data
(60) Provisional application No. 63/268,564, filed on Feb. 25, 2022.

(51) Int. Cl. G01S 17/26; G01S 7/4865; G01S 7/484

(52) U.S. Cl. CPC G01S 17/26; G01S 7/484; G01S 7/4865

(57) ABSTRACT

In some implementations, a light detection and ranging (LIDAR) system may generate a transmission signal by modulating a signal with a first signal and a second signal. The signal may be modulated with the first signal using a first combination of polarization and phase and with the second signal using a second combination of polarization and phase. The LIDAR system may transmit the transmission signal and receive a reception signal that is based on a reflection of the transmission signal from an object. The LIDAR system may mix the reception signal with the oscillator laser signal to generate a first detection signal associated with the first signal and a second detection signal associated with the second signal, and may determine a first phase shift of the first signal based on the first detection signal and a second phase shift of the second signal based on the second detection signal.

### CROSS REFERENCE TO RELATED APPLICATION

This Patent Application claims priority to U.S. Provisional Pat. Application No. 63/268,564, filed on Feb. 25, 2022, and entitled “SWITCHABLE MULTI-TONE COHERENT LIGHT DETECTION AND RANGING.” The disclosure of the prior Application is considered part of and is incorporated by reference into this Patent Application.

### TECHNICAL FIELD

The present disclosure relates generally to light detection and ranging (LIDAR) and to multi-tone coherent LIDAR.

### BACKGROUND

A LIDAR system may produce an optical beam (e.g., a laser beam or the like), scan the optical beam across a field of view including one or more objects, receive a beam reflected from objects in the field of view, process the received beam, and determine three-dimensional aspects of the one or more objects. For example, the LIDAR system, based on light reflected from objects in the field of view, may construct a point cloud to determine the three-dimensional aspects of the one or more objects. A LIDAR system may include a scanner for scanning an optical beam across a field of view, receiving light reflected from the field of view, and providing the light reflected from the field of view to a receiver for processing.

### SUMMARY

In some implementations, a LIDAR system may include a transmission signal processor configured to generate a first signal and a second signal, where a first frequency of the first signal is different from a second frequency of the second signal. The LIDAR system may include multiple optical modulators configured to generate a transmission signal by modulating an oscillator laser signal with the first signal and the second signal, where the oscillator laser signal is to be modulated with the first signal using a first combination of polarization and phase and with the second signal using a second combination of polarization and phase, and where the LIDAR system is configured to transmit the transmission signal and receive a reception signal that is based on a reflection of the transmission signal from an object. The LIDAR system may include an integrated coherent receiver configured to mix the reception signal with the oscillator laser signal to generate a first detection signal associated with the first signal and a second detection signal associated with the second signal. The LIDAR system may include a reception signal processor configured to determine a first phase shift of the first signal based on the first detection signal and a second phase shift of the second signal based on the second detection signal, and generate information that indicates a first distance of the object based on the first phase shift and a second distance of the object based on the second phase shift, where the first distance and the second distance are with respect to different distance resolutions.

In some implementations, a method may include generating, by a LIDAR system, a transmission signal by modulating an oscillator laser signal with a first signal and a second signal, where a first frequency of the first signal is different from a second frequency of the second signal, and where the oscillator laser signal is modulated with the first signal using a first combination of polarization and phase and with the second signal using a second combination of polarization and phase. The method may include transmitting, by the LIDAR system, the transmission signal. The method may include receiving, by the LIDAR system, a reception signal that is based on a reflection of the transmission signal from an object. The method may include mixing, by the LIDAR system, the reception signal with the oscillator laser signal to generate a first detection signal associated with the first signal and a second detection signal associated with the second signal. The method may include determining, by the LIDAR system, a first phase shift of the first signal based on the first detection signal and a second phase shift of the second signal based on the second detection signal. The method may include generating, by the LIDAR system, information that indicates a first distance of the object based on the first phase shift and a second distance of the object based on the second phase shift, where the first distance and the second distance are with respect to different distance resolutions.

In some implementations, a coherent LIDAR system may include a transmission signal processor configured to generate a first signal and a second signal, where a first frequency of the first signal is different from a second frequency of the second signal. The coherent LIDAR system may include an integrated coherent transmitter including a first optical modulator and a second optical modulator configured to generate a transmission signal by modulating an oscillator laser signal with the first signal and the second signal, where the oscillator laser signal is to be modulated with the first signal using a first combination of polarization and phase and with the second signal using a second combination of polarization and phase, and where the coherent LIDAR system is configured to transmit the transmission signal and receive a reception signal that is based on a reflection of the transmission signal from an object. The coherent LIDAR system may include an integrated coherent receiver configured to mix the reception signal with the oscillator laser signal to generate a first detection signal associated with the first signal and a second detection signal associated with the second signal. The coherent LIDAR system may include a reception signal processor configured to determine a first phase shift of the first signal based on the first detection signal and a second phase shift of the second signal based on the second detection signal, and determine a first distance of the object based on the first phase shift and a second distance of the object based on the second phase shift, where the first distance and the second distance are with respect to different distance resolutions.

### BRIEF DESCRIPTION OF THE DRAWINGS

FIG. 1 is a diagram of an example LIDAR system.

FIG. 2A is a diagram of an example transmitter.

FIG. 2B is a diagram of an example optical modulator component.

FIG. 2C is a diagram of an example of signals generated by optical modulators.

FIG. 2D is a diagram of an example of a transmission signal processor.

FIG. 3A is a diagram of an example receiver.

FIG. 3B is a diagram of an example of a reception signal processor.

FIG. 4 is a diagram of an example hardware system.

FIG. 5 is a flowchart of an example process relating to multi-tone coherent LIDAR.

### DETAILED DESCRIPTION

The following detailed description of example implementations refers to the accompanying drawings. The same reference numbers in different drawings may identify the same or similar elements.

LIDAR may use a frequency modulated continuous wave (FMCW) approach or a time of flight (TOF) approach. In FMCW LIDAR, laser light may be chirped to sweep in frequency. Due to practical reception bandwidth limitations, FMCW LIDAR may suitably provide only two of: range, precision, and acquisition rate. For example, FMCW LIDAR may be associated with high precision, high acquisition rate, and short range, may be associated with low precision, high acquisition rate, and long range, or may be associated with high precision, low acquisition rate, and long range. In TOF LIDAR, distance may be measured based on a time interval that has elapsed between a launched pulse and a received pulse. Direct TOF LIDAR may be limited by timing accuracy (e.g., limited to a centimeter or greater resolution). Indirect TOF LIDAR uses phase detection of a single modulation tone, and therefore must trade off between range and range resolution.

Some implementations described herein provide a multi-signal (e.g., multi-tone) coherent LIDAR system (e.g., that operates in a self-homodyne mode with a single oscillator laser). For example, the LIDAR system may perform range detection based on a measured phase deviation, of multiple sinusoidal tones, between a received tone and a transmitted tone. The different frequencies of the multiple tones may provide different distance resolutions for the LIDAR system. For example, a first tone may be associated with a first frequency that enables meter resolution, and a second tone may be associated with a second frequency that enables millimeter resolution. Thus, for long distance measurements, lower tone frequencies may be used, and for high range precision, higher tone frequencies may be used. For example, the LIDAR system may achieve, simultaneously, coarse ranging using a first tone over a large scan area, while also achieving accurate local area measurements using a second tone. In this way, the use of multiple tones provides both long range and high distance resolution for the LIDAR system.

Moreover, the frequencies of the tones may be configured in order to satisfy various application ranges and/or resolutions. That is, the tones used by the LIDAR system may be switchable (e.g., to optimize a speed and/or a resolution of data acquisition). For example, a user of the LIDAR system may define the frequencies in order to tailor the LIDAR system for a particular application or use. In metrology, an ability to simultaneously achieve increased range, high range resolution, and high acquisition rate may improve inline inspection. For autonomous vehicles, the LIDAR system may provide fast detection and improved acquisition rate to achieve three-dimensional point clouds with improved resolution and/or improved frame rate. In this way, the LIDAR system is adaptable for different applications or use cases.

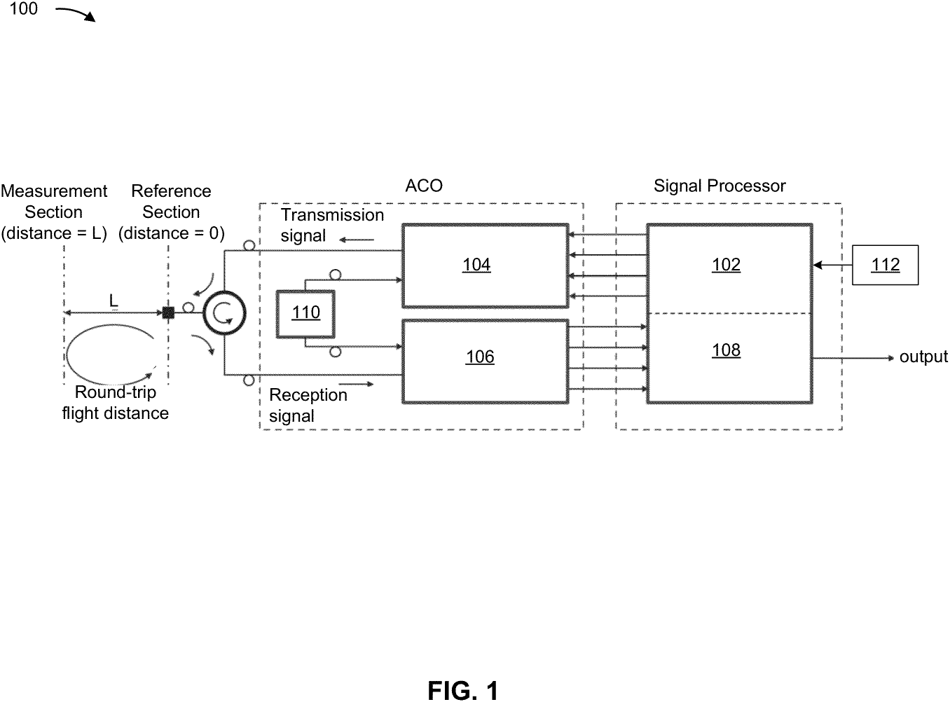

FIG. 1 is a diagram of an example LIDAR system 100. As shown in FIG. 1, the LIDAR system 100 may include a transmission (TX) signal processor 102 (e.g., a digital signal processor (DSP)), an integrated coherent transmitter 104, an integrated coherent receiver 106, a reception (RX) signal processor 108 (e.g., a DSP), and/or an oscillator laser 110 (e.g., a local oscillator (LO)). As shown, the integrated coherent transmitter 104, the integrated coherent receiver 106, and the oscillator laser 110 may be configured in an analog coherent optics (ACO) architecture.

The transmission signal processor 102 may be configured to generate multiple feedback signals (e.g., with a specified amplitude, frequency, and phase alignment) used for modulating a carrier signal. For example, the transmission signal processor 102 may be configured to generate multiple feedback tones used for modulating a carrier signal. The integrated coherent transmitter 104 may be configured to generate and launch a transmission signal by modulating a signal (e.g., a carrier signal) of the oscillator laser 110 with the multiple feedback signals generated by the transmission signal processor 102. In some implementations, a modulation format of the transmission signal may include dual-polarization quadrature phase-shift keying (DP-QPSK). That is, the transmission signal may be a DP-QPSK signal.

The integrated coherent receiver 106 may be configured to receive a reception signal that is based on a reflection of the transmission signal from an object (e.g., in a field of view of the LIDAR system 100). For example, the reception signal may be a DP-QPSK signal. Furthermore, the integrated coherent receiver 106 may be configured to mix the reception signal with a signal of the oscillator laser 110 to generate multiple detection signals associated with the multiple feedback signals. Thus, the LIDAR system 100 may be a coherent LIDAR system.

The reception signal processor 108 may be configured to provide polarization, demultiplexing, optical phase alignment, and relative phase offset measurement for the multiple feedback signals. In particular, the reception signal processor 108 may be configured to identify, based on the detection signals, phase shifts between the transmitted feedback signals and the received (e.g., reflected) feedback signals. That is, the reception signal processor 108 may measure the relative phase of each feedback signal (e.g., each feedback tone) between transmission and reception. In some implementations, the LIDAR system 100 may be configured to provide the same phase processing for both transmission and reception. In addition, phase calibration is not needed between the electrical transmission path and the electrical reception path of the LIDAR system 100.

As shown, laser light from the oscillator laser 110 may be split and provided to an optical modulator of the integrated coherent transmitter 104 and to the integrated coherent receiver 106 to serve as the local oscillator.

In some implementations, the LIDAR system 100 may include an input component 112. The input component 112 may include one or more devices (e.g., a button, a knob, a keyboard, and/or a touchscreen, among other examples) that are configured to receive an input from a user of the LIDAR system 100. In some implementations, the input component 112 may include an interface of the LIDAR system that is configured to receive information from the one or more devices. The input component 112 may be in communication with the transmission signal processor 102. The input component 112 may be configured to obtain, from the user, an input of one or more values indicating one or more frequencies that are to be used for the multiple feedback signals (e.g., the multiple tones). For example, the input component 112 may be configured to obtain an input of a first value for a first frequency that is to be used for a first feedback signal and/or a second value for a second frequency that is to be used for the second feedback signal. In this way, the LIDAR system 100 facilitates tuning of the multiple feedback signals to achieve ranging that is tailored for a particular use or application of the LIDAR system 100.

In some implementations, the input component 112 may be configured to obtain, from the user, an input of a ranging distance and/or a resolution. For example, the ranging distance and/or the resolution may be associated with a particular application for which the LIDAR system is to be used. In some implementations, the transmission signal processor 102 may be configured to generate the multiple feedback signals based on the ranging distance and/or the resolution. For example, the transmission signal processor 102 may determine frequencies that achieve the ranging distance and/or the resolution, and the transmission signal processor 102 may generate multiple feedback signals based on the frequencies that are determined.

In some implementations, the LIDAR system 100 may employ artificial intelligence, such as machine learning, to facilitate data acquisition with improved distance resolution, speed, and/or repeatability. For example, the LIDAR system 100 may determine a configuration for the feedback signals (e.g., the frequencies for the feedback signals), or another configuration for the LIDAR system 100, using a machine learning model. In particular, the machine learning model may be trained to determine one or more configurations that prioritize resolution, that prioritize speed, or that strike a particular balance between resolution and speed, based on an application for which the LIDAR system 100 is to be used, a type of a target, a material of a target, and/or environmental conditions associated with the LIDAR system 100, among other examples.

As indicated above, FIG. 1 is provided as an example. Other examples may differ from what is described with regard to FIG. 1.

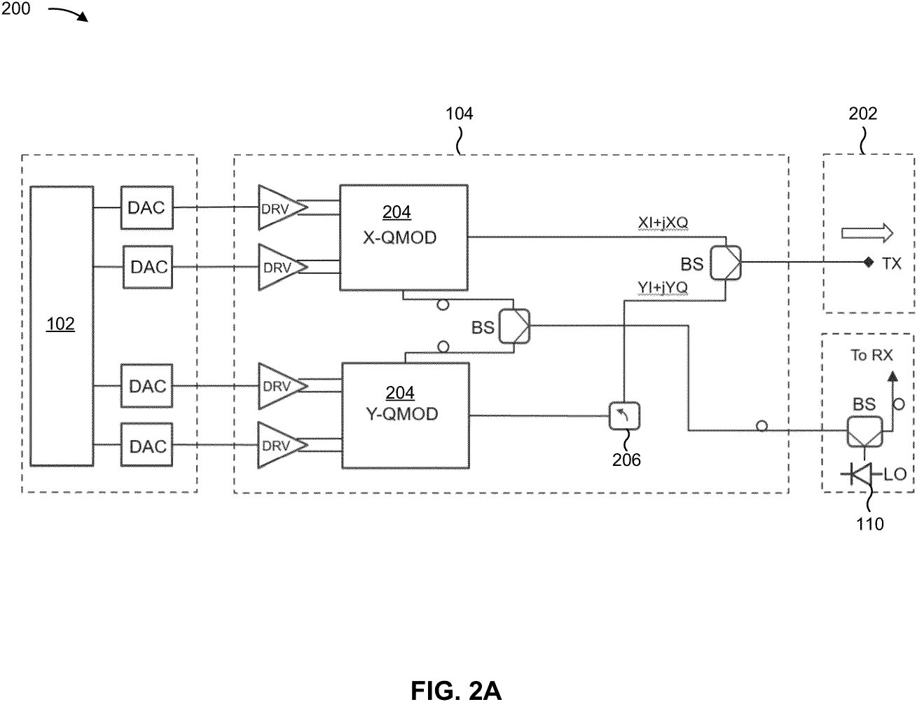

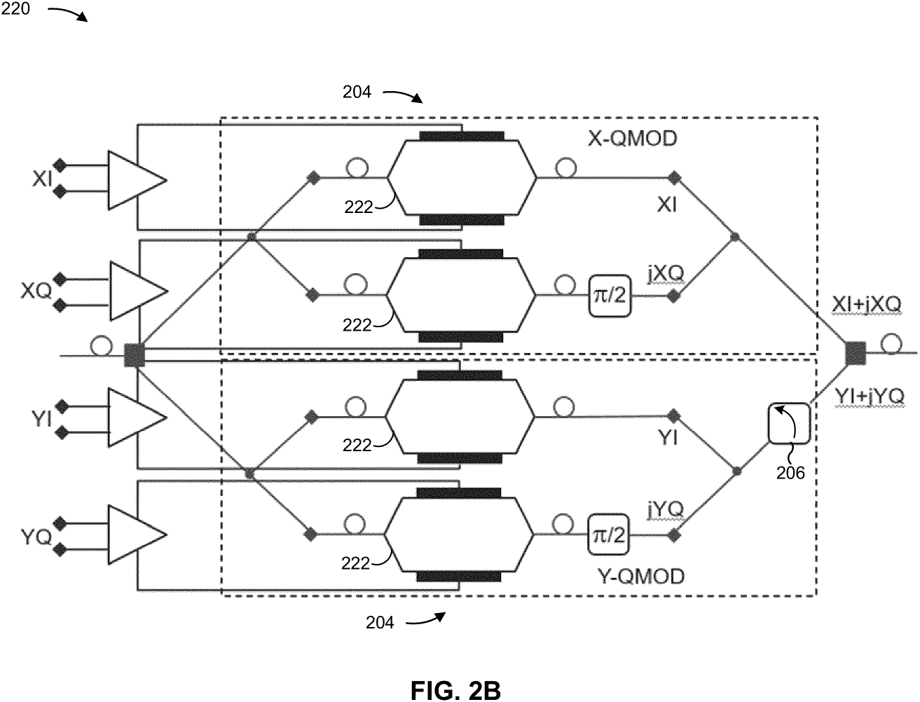

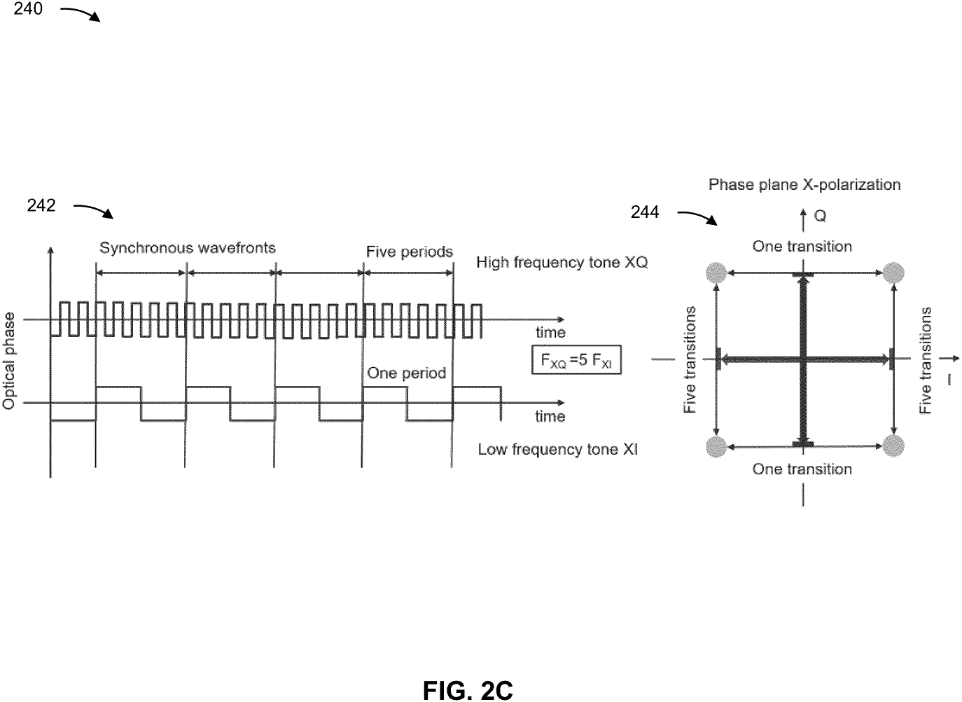

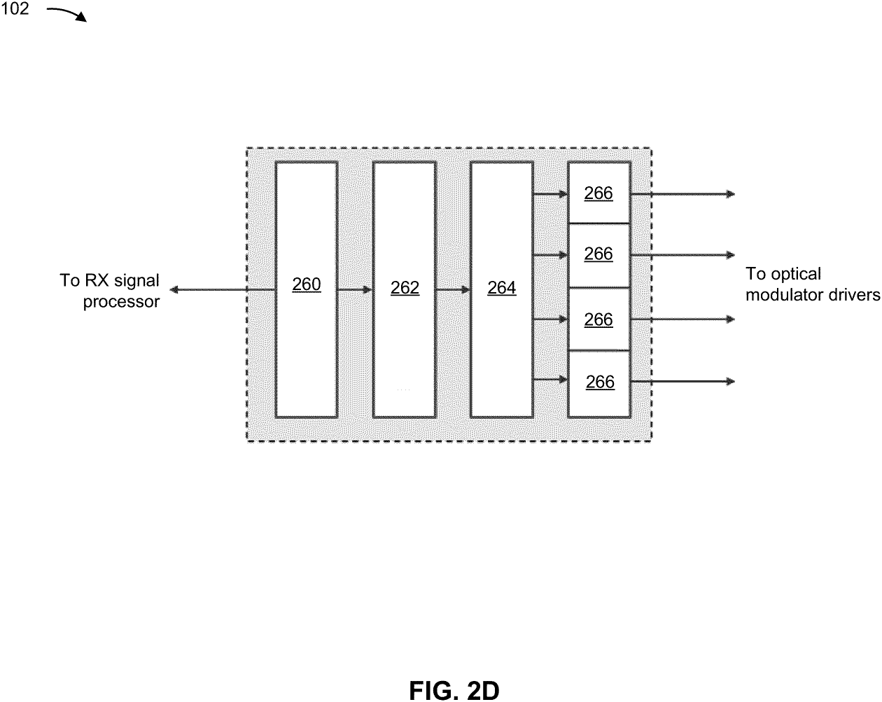

FIG. 2A is a diagram of an example transmitter 200. For example, the transmitter 200 may be included in the LIDAR system 100. Accordingly, the transmitter 200 may include the transmission signal processor 102 and the integrated coherent transmitter 104. In addition, the transmitter 200 may include transmission optics 202 (e.g., one or more lenses, or the like). Moreover, the transmitter 200 may include other components, such as one or more digital-to-analog converters (DACs), one or more driver (DRV) amplifiers, and/or one or more beam splitters (BSs) (e.g., which may be used for beam combination in some cases), as shown.

The integrated coherent transmitter 104 may include an optical modulator component (e.g., a dual polarization (DP) and in-phase and quadrature (IQ) modulator) that provides modulation of a signal of the oscillator laser 110 with multiple feedback signals (e.g., multiple feedback tones) generated by the transmission signal processor 102, as described herein. For example, as shown, the optical modulator component of the integrated coherent transmitter 104 may include multiple quadrature modulation components 204. The optical modulator component may include a polarization rotator 206 at an output of one of the quadrature modulation components 204. For example, the quadrature modulation components 204 may include a first quadrature modulation component 204 associated with X-plane (e.g., horizontal) polarization and a second quadrature modulation component 204 associated with Y-plane (e.g., vertical) polarization (shown as X-QMOD and Y-QMOD). The optical modulator component may be configured to provide up to four different field modes, which include two orthogonal polarizations (X-plane polarization and Y-plane polarization) and two quadrature optical phases (in-phase (I) and quadrature (Q)). Thus, the LIDAR system 100 may support up to four different feedback tones: XI (for a first tone), XQ (for a second tone), YI (for a third tone), and YQ (for a fourth tone). Accordingly, the transmitter 200 may be configured to transmit each feedback tone (e.g., up to four feedback tones) on a different optical phase and polarization combination.

In one example, the transmission signal processor 102 may be configured to generate multiple (e.g., up to four) feedback signals (e.g., multiple feedback tones), where the multiple feedback signals have different frequencies from each other. For example, the multiple feedback signals may include a first feedback signal and a second feedback signal, and a first frequency of the first signal may be different from (e.g., lower than) a second frequency of the second signal. As an example, the first frequency may be for ranging at a first distance resolution (e.g., a meter resolution), and the second frequency may be for ranging at a second distance resolution (e.g., a millimeter resolution). Here, a wavelength of a higher-frequency feedback signal may correspond to twice a spatial resolution that can be achieved by a lower-frequency feedback signal. For example, a wavelength of the second frequency may correspond to a distance resolution that is at least twice a distance resolution that corresponds to a wavelength of the first frequency. In some implementations, the multiple feedback signals may include a first feedback signal of a first frequency for ranging at a meter resolution, a second feedback signal of a second frequency for ranging at a centimeter resolution, and a third feedback signal of a third frequency for ranging at a millimeter resolution. A maximum distance of a feedback signal may be based on a frequency of the feedback signal, and a distance resolution for the maximum distance may be based on a phase measurement resolution. For example, for a feedback signal at 1.5 gigahertz, a maximum distance is 10 centimeters, and with a phase resolution of 3.6 degrees, a distance resolution is 0.1 millimeters.

The integrated coherent transmitter 104 (e.g., using at least one optical modulator, as described in connection with FIG. 2B) may be configured to generate a transmission signal by modulating an oscillator laser signal (e.g., from the oscillator laser 110) with the multiple feedback signals. For example, the integrated coherent transmitter 104 (e.g., using at least one optical modulator 222) may be configured to generate the transmission signal by modulating the oscillator laser signal with the first feedback signal and the second feedback signal. In some implementations, the transmission signal is further generated by modulating the oscillator laser signal with a third feedback signal and/or a fourth feedback signal. The modulation of the oscillator laser signal with the multiple feedback signals may be performed in any manner described herein (e.g., using DP-QPSK modulation).

For example, the multiple feedback signals may have different combinations of polarization and phase from each other. In particular, the integrated coherent transmitter 104 may be configured to modulate the oscillator laser signal with the first signal using a first combination of polarization and phase and with the second signal using a second combination of polarization and phase. For example, the first combination of polarization and phase may use one of an X-plane polarization or a Y-plane polarization, and the second combination of polarization and phase may use the other one of the X-plane polarization or the Y-plane polarization, and/or the first combination of polarization and phase may use one of an in-phase signal component or a quadrature signal component, and the second combination of polarization and phase may use the other one of the in-phase signal component or the quadrature signal component. Thus, where up to four feedback signals are used, the integrated coherent transmitter 104 may be configured to modulate the oscillator laser signal with the third signal using a third combination of polarization and phase and/or with the fourth signal using a fourth combination of polarization and phase. In other words, a feedback signal may use one of: a combination of X-plane polarization and an in-phase signal component, a combination of X-plane polarization and a quadrature signal component, a combination of Y-plane polarization and an in-phase signal component, or a combination of Y-plane polarization and a quadrature signal component (e.g., such that up to four different feedback signals can be used).

The integrated coherent transmitter 104 (e.g., using the transmission optics 202) may be configured to transmit the transmission signal that is generated (e.g., at one or more objects in a field of view of the LIDAR system 100).

As indicated above, FIG. 2A is provided as an example. Other examples may differ from what is described with regard to FIG. 2A.

FIG. 2B is a diagram of an example optical modulator component 220. For example, the optical modulator component 220 may be included in the transmitter 200. As shown, the optical modulator component 220 may include multiple (shown as four) optical modulators 222. The optical modulators 222 may be nested, as shown. In some implementations, the optical modulators 222 may include Mach-Zehnder modulators (MZMs), as shown.

Each optical modulator 222 may generate a modulated optical signal for one combination of optical phase and polarization. In other words, a quantity of optical modulators 222 of the optical modulator component 220 may correspond to a quantity of feedback signals for a transmission signal of the LIDAR system 100. For example, the optical modulator component 220 may include a first optical modulator 222 for a first feedback signal, a second optical modulator 222 for a second feedback signal, and so forth.

In some implementations, the optical modulator component 220 may include a single optical modulator 222 (or a quantity of optical modulators 222 that is less than a quantity of feedback signals for the transmission signal). Here, the optical modulator 222 may modulate multiple feedback signals in a time-division multiplexed manner (e.g., using time-division multiplexing). For example, the optical modulator 222 may modulate the first feedback signal and the second feedback signal in a time-division multiplexed manner. In this case, the modulated feedback signals may use the same polarization and/or the same phase.

As indicated above, FIG. 2B is provided as an example. Other examples may differ from what is described with regard to FIG. 2B.

FIG. 2C is a diagram of an example 240 of signals generated by optical modulators. For example, the optical modulators may be the optical modulators 222.

As shown by plot 242, the feedback signals described herein may include a relatively high-frequency tone and a relatively low-frequency tone. As shown, an optical phase signal at an output of an optical modulator may have a square wave profile (e.g., because of bias at null), independent of (e.g., regardless of) a wave shape of a driving signal. As shown by reference number 244, in some implementations, the optical transmission signal may be a DP-QPSK signal, where each tributary may carry a bi-polar, on-off periodic signal.

As indicated above, FIG. 2C is provided as an example. Other examples may differ from what is described with regard to FIG. 2C.

FIG. 2D is a diagram of an example of the transmission signal processor 102. As described herein, the transmission signal processor 102 may be a DSP. As shown, the transmission signal processor 102 may include a clock component 260, an arbitrary waveform generator (AWG) 262 (e.g., a four-channel AWG), a delay adjustment component 264, and/or one or more DACs 266.

The transmission signal processor 102 may use a clock signal of the clock component 260 to perform one or more operations. In some implementations, the clock signal of the clock component 260 may be provided to the reception signal processor 108. As described herein, the transmission signal processor 102 may be configured to generate (e.g., using the AWG 262) samples of each feedback signal (e.g., of each feedback tone) according to a specified amplitude, frequency, and phase. The generated feedback signals may have synchronous wavefronts, where zero-crossing instants scale with the frequencies of the feedback signals (e.g., the feedback tones). The transmission signal processor 102 may be configured to provide each generated feedback signal to a respective DAC 266. The DACs 266 may be configured to output to respective drivers for the optical modulators 222 (e.g., the MZMs). For example, a quantity of DACs 266 may correspond to a quantity of optical modulators 222 of the optical modulator component 220, and each DAC 266 may output to a respective optical modulator 222. The delay adjustment component 264 may enable a programmable delay used for aligning delay variation of the drivers.

As indicated above, FIG. 2D is provided as an example. Other examples may differ from what is described with regard to FIG. 2D.

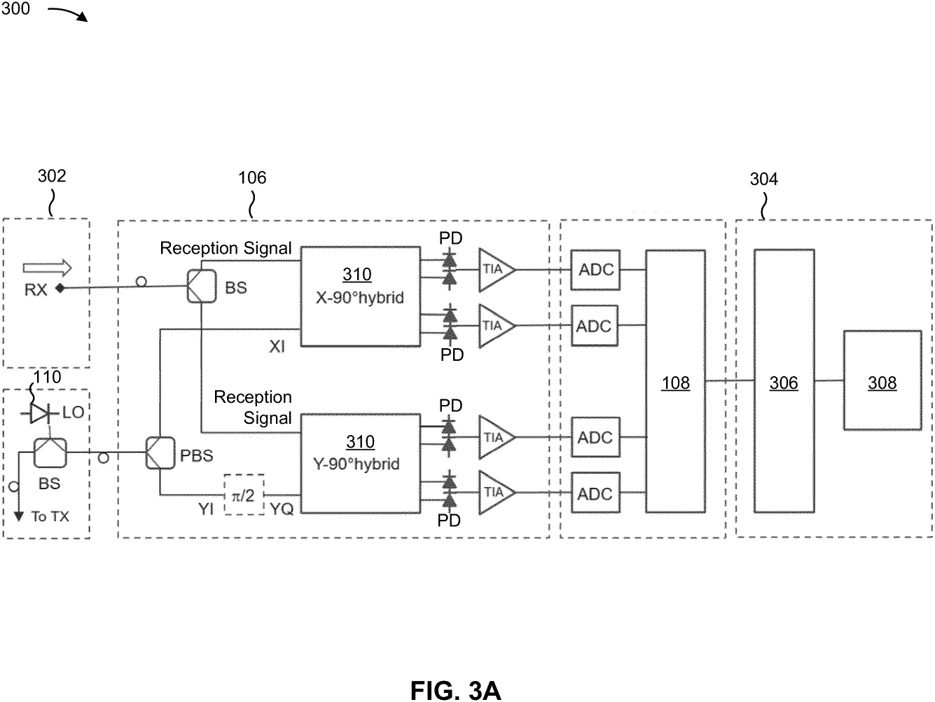

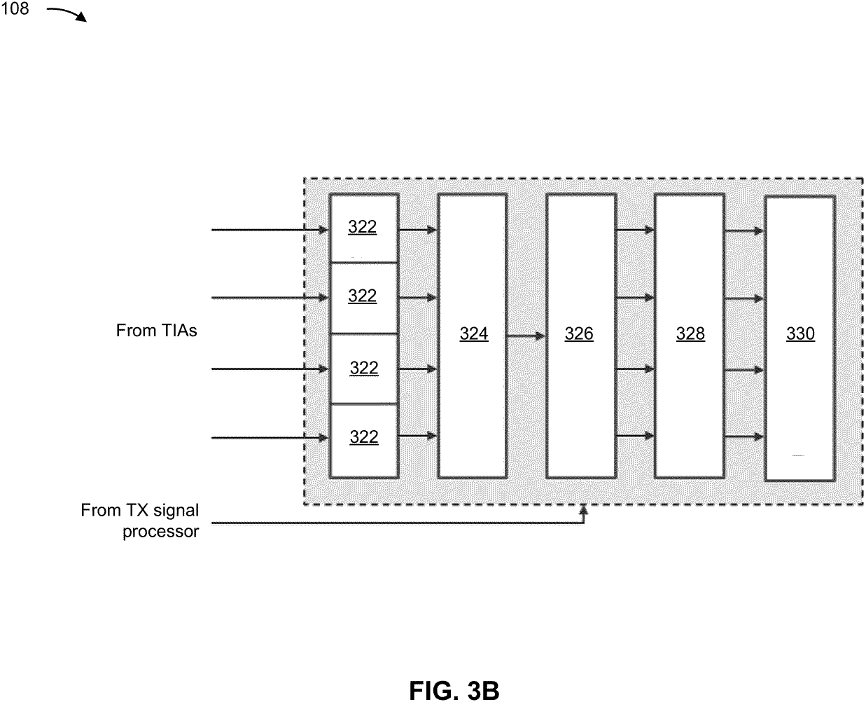

FIG. 3A is a diagram of an example receiver 300. For example, the receiver 300 may be included in the LIDAR system 100. Accordingly, the receiver 300 may include the integrated coherent receiver 106 and the reception signal processor 108. In addition, the receiver 300 may include reception optics 302 (e.g., one or more lenses, or the like). Moreover, the receiver 300 may include other components, such as one or more analog-to-digital converters (ADCs), one or more transimpedance amplifiers (TIAs), one or more photodiodes (PDs), and/or one or more BSs, as shown. Furthermore, the receiver 300 may include, or may be in communication with, an output component 304. The output component 304 may include a graphical rendering component 306 that is configured to generate a graphical representation of an output of the reception signal processor 108 (e.g., indicating a distance of one or more objects and/or depicting an environment of the LIDAR system 100) and/or a display 308 on which the graphical representation is to be presented.

The integrated coherent receiver 106 may include an optical demodulator component that provides demodulation of a reception signal by mixing the reception signal with the signal of the oscillator laser 110, as described herein. For example, as shown, the optical demodulator component of the integrated coherent receiver 106 may include multiple optical hybrid mixers 310 (e.g., 90° optical hybrid mixers), such as a first optical hybrid mixer 310 in connection with X-polarization and a second optical hybrid mixer 310 in connection with Y-polarization (shown as X-90° hybrid and Y-90° hybrid), configured to provide coherent signal demodulation.

The integrated coherent receiver 106 (e.g., using the reception optics 302) may be configured to receive a reception signal that is based on a reflection of the transmission signal from an object. The carrier signal and the feedback signals of the reflected signal may experience phase shifts and Doppler frequency shifts. The integrated coherent receiver 106 (e.g., using the optical demodulator component) may be configured to mix the reception signal with the oscillator laser signal (e.g., from the oscillator laser 110) to generate multiple detection signals associated with the multiple feedback signals (e.g., the integrated coherent receiver 106 may combine the reception signal with the oscillator laser signal to generate baseband I- and Q-signal components of a beat-frequency signal). For example, the integrated coherent receiver 106 may be configured to mix the reception signal with the oscillator laser signal (e.g., at each of the optical hybrid mixers 310) to generate a first detection signal associated with the first feedback signal, a second detection signal associated with the second feedback signal, and so forth. The detection signals may be converted to an electrical domain by the PDs (as used herein, a “detection signal” may refer to an output of an optical hybrid mixer 310 or an output of a PD, which converts the output of the optical hybrid mixer 310 to an electrical domain).

The reception signal processor 108 (described further in connection with FIG. 3B) may be configured to determine, based on the multiple detection signals, phase shifts of the multiple feedback signals (e.g., the feedback signals of the transmission signal may accumulate respective phase shifts during the round-trip time of flight that are proportional to the distance of the object). For example, the reception signal processor 108 may be configured to determine a first phase shift of the first feedback signal based on the first detection signal and a second phase shift of the second feedback signal based on the second detection signal. Moreover, the reception signal processor 108 may be configured to determine, and generate information that indicates, multiple distances of the object, from the LIDAR system 100, based on the phase shifts. For example, the reception signal processor 108 may be configured to determine, and generate information that indicates, a first distance of the object based on the first phase shift and a second distance of the object based on the second phase shift. The multiple distances (e.g., the first distance and the second distance) may be with respect to different distance resolutions (e.g., a distance resolution may be proportional to a resolution of a phase measurement). For example, the first distance may indicate a distance of the object with respect to a first distance resolution (e.g., a meter distance resolution) and the second distance may indicate a distance of the object with respect to a second distance resolution (e.g., a millimeter distance resolution). In this way, the LIDAR system 100 is capable of providing coarse and fine ranging. For example, a highest-frequency feedback signal that is used may define an accuracy of the LIDAR system 100.

In some implementations, the reception signal processor 108 also may be configured to determine a Doppler frequency shift experienced by the reception signal (e.g., with respect to the carrier frequency). That is, the reception signal processor 108 may determine a Doppler frequency shift between the transmission signal (e.g., the laser oscillator signal) and the reception signal. Here, the reception signal processor 108 may determine, and generate information that indicates, a velocity of the object based on the frequency shift.

As indicated above, FIG. 3A is provided as an example. Other examples may differ from what is described with regard to FIG. 3A.

FIG. 3B is a diagram of an example of the reception signal processor 108. As described herein, the reception signal processor 108 may be a DSP. As shown, the reception signal processor 108 may include one or more ADCs 322, a polarization demultiplexer component 324, a phase alignment component 326, a tone phase offset component 328, and/or a distance calculation component 330. As shown, signals from the TIAs of the receiver 300 may be input to the ADCs 322.

As described herein, a clock signal from the transmission signal processor 102 may be input to the reception signal processor 108, and the reception signal processor 108 may use the clock signal to perform one or more operations. The ADCs 322 may be configured to sample the signals from the TIAs and convert the samples to digital samples. The polarization demultiplexer component 324 may be configured to separate quadrature signals that belong to respective orthogonal polarizations. The phase alignment component 326 may be configured to align the optical phase of the reception signal with the phase of the laser oscillator signal. After phase alignment, each output lane (e.g., electrical trace) from the phase alignment component 326 may provide a single feedback signal (e.g., a single feedback tone) to the phase offset component 328, which may provide phase offset discrimination used for distance calculation of the distance calculation component 330.

In some implementations, the reception signal processor 108 (and/or the transmission signal processor 102) may be configured to track polarization rotations from a launched field (e.g., a transmission signal) to a reflected field (e.g., a reception signal). The reception signal processor 108 may use information relating to a polarization rotation to perform accurate polarization demultiplexing to separate X-plane and Y-plane polarization signals.

In some implementations, the reception signal processor 108 may include one or more successive approximation register digital phase-locked loops (SAR-DPLLs). For example, the reception signal processor 108 may include multiple SAR-DPLLs corresponding to the multiple feedback signals in the reception signal. In particular, the reception signal processor 108 may include a first SAR-DPLL (e.g., for the first feedback signal in the reception signal) and a second SAR-DPLL (e.g., for the second feedback signal in the reception signal). The reception signal processor 108 may be configured to determine the phase shifts between the reception signal and the transmission signal with respect to the multiple feedback signals using the SAR-DPLLs. For example, the reception signal processor 108 may be configured to determine the first phase shift relating to the first signal using the first SAR-DPLL and the second phase shift relating to the second signal using the second SAR-DPLL.

The SAR-DPLLs may facilitate accurate and fast distance measurement, such as in less than 100 nanoseconds. Moreover, the SAR-DPLLs may facilitate distance measurement in a fixed processing interval, regardless of frequencies of the feedback signals or a distance of a target. In some implementations, a resolution (e.g., a quantity of bits) of the SAR-DPLLs may be selected to optimize speed and resolution.

In some implementations, the reception signal processor 108 may include one or more logic gates (e.g., XOR logic gates). For example, the reception signal processor 108 may include multiple logic gates corresponding to the multiple feedback signals in the reception signal. In particular, the reception signal processor 108 may include a first logic gate, such as a first XOR gate (e.g., for the first feedback signal in the reception signal), and a second logic gate, such as a second XOR gate (e.g., for the second feedback signal in the reception signal). The reception signal processor 108 may be configured to determine the phase shifts between the reception signal and the transmission signal with respect to the multiple feedback signals using the logic gates. For example, the reception signal processor 108 may be configured to determine the first phase shift relating to the first signal using the first logic gate and the second phase shift relating to the second signal using the second logic gate (e.g., based on a distance between two wavefronts, such as a detection signal and a clock signal, indicated by an output of a logic gate).

As indicated above, FIG. 3B is provided as an example. Other examples may differ from what is described with regard to FIG. 3B.

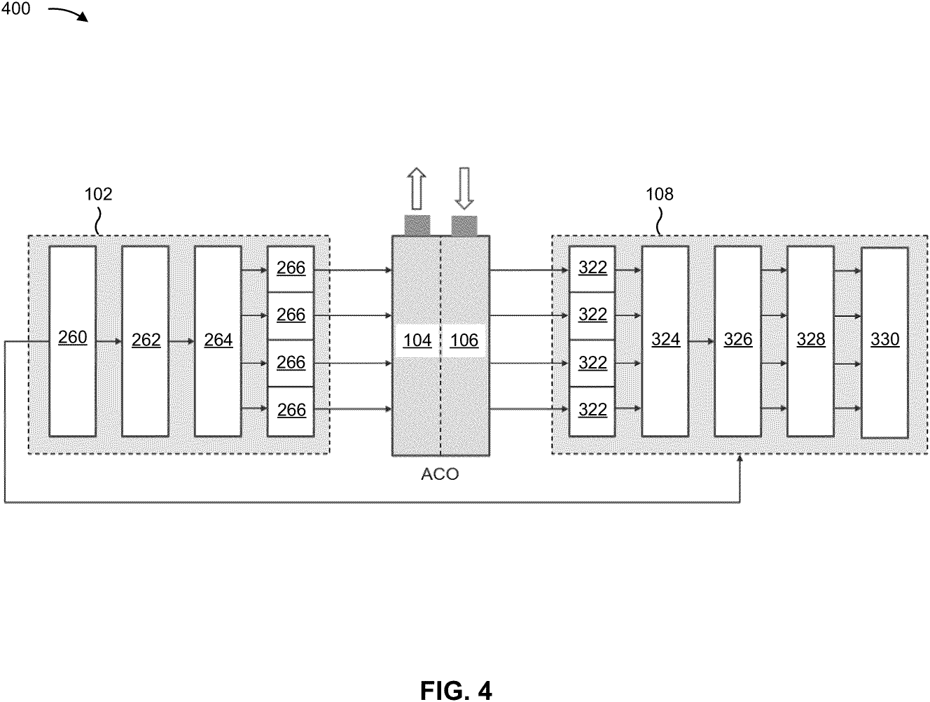

FIG. 4 is a diagram of an example hardware system 400. For example, the hardware system 400 may be included in the LIDAR system 100. As shown, the hardware system 400 may include the transmission signal processor 102 and the reception signal processor 108. In some implementations, the transmission signal processor 102 and the reception signal processor 108 may be included on the same chip, and the chip may be assembled with an ACO system that includes the integrated coherent transmitter 104 and the integrated coherent receiver 106.

As indicated above, FIG. 4 is provided as an example. Other examples may differ from what is described with regard to FIG. 4.

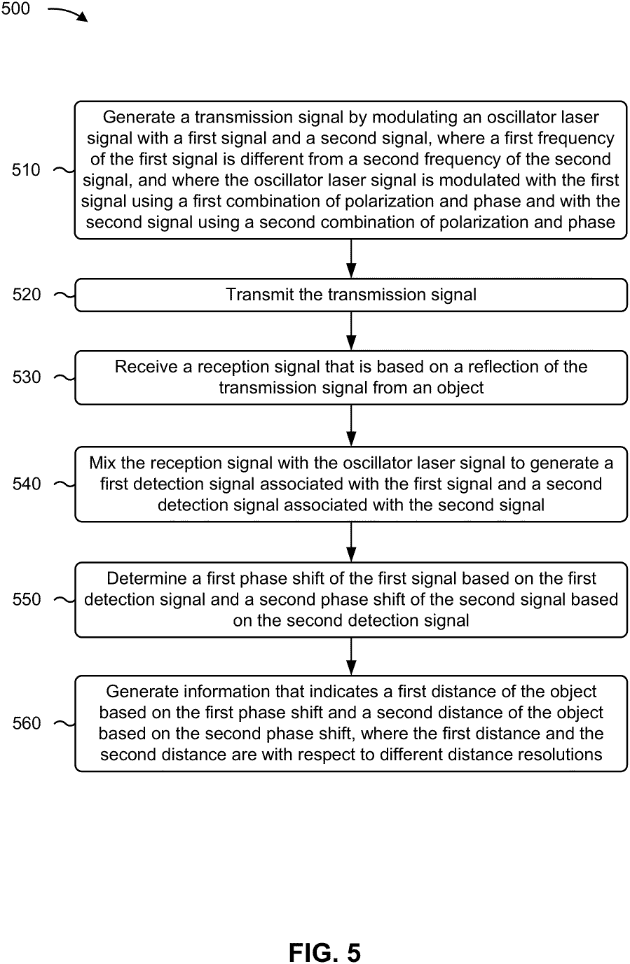

FIG. 5 is a flowchart of an example process 500 associated with multi-tone coherent LIDAR. In some implementations, one or more process blocks of FIG. 5 are performed by a device, such as a LIDAR system (e.g., LIDAR system 100). In some implementations, one or more process blocks of FIG. 5 are performed by another device or a group of devices separate from or included in the LIDAR system, such as the transmission signal processor 102, the integrated coherent transmitter 104, the integrated coherent receiver 106, and/or the reception signal processor 108.

As shown in FIG. 5, process 500 may include generating a transmission signal by modulating an oscillator laser signal with a first signal and a second signal, where a first frequency of the first signal is different from a second frequency of the second signal, and where the oscillator laser signal is modulated with the first signal using a first combination of polarization and phase and with the second signal using a second combination of polarization and phase (block 510). For example, the LIDAR system may generate a transmission signal by modulating an oscillator laser signal with a first signal and a second signal, as described above. In some implementations, a first frequency of the first signal is different from a second frequency of the second signal. In some implementations, the oscillator laser signal is modulated with the first signal using a first combination of polarization and phase and with the second signal using a second combination of polarization and phase.

As further shown in FIG. 5, process 500 may include transmitting the transmission signal (block 520). For example, the LIDAR system may transmit the transmission signal, as described above.

As further shown in FIG. 5, process 500 may include receiving a reception signal that is based on a reflection of the transmission signal from an object (block 530). For example, the LIDAR system may receive a reception signal that is based on a reflection of the transmission signal from an object, as described above.

As further shown in FIG. 5, process 500 may include mixing the reception signal with the oscillator laser signal to generate a first detection signal associated with the first signal and a second detection signal associated with the second signal (block 540). For example, the LIDAR system may mix the reception signal with the oscillator laser signal to generate a first detection signal associated with the first signal and a second detection signal associated with the second signal, as described above.

As further shown in FIG. 5, process 500 may include determining a first phase shift of the first signal based on the first detection signal and a second phase shift of the second signal based on the second detection signal (block 550). For example, the LIDAR system may determine a first phase shift of the first signal based on the first detection signal and a second phase shift of the second signal based on the second detection signal, as described above.

As further shown in FIG. 5, process 500 may include generating information that indicates a first distance of the object based on the first phase shift and a second distance of the object based on the second phase shift, where the first distance and the second distance are with respect to different distance resolutions (block 560). For example, the LIDAR system may generate information that indicates a first distance of the object based on the first phase shift and a second distance of the object based on the second phase shift, as described above. In some implementations, the first distance and the second distance are with respect to different distance resolutions.

Process 500 may include additional implementations, such as any single implementation or any combination of implementations described below and/or in connection with one or more other processes described elsewhere herein.

In a first implementation, process 500 includes receiving an input of at least one of a first value for the first frequency of the first signal or a second value for the second frequency of the second signal.

In a second implementation, alone or in combination with the first implementation, at least one of: the first combination of polarization and phase uses one of an X-plane polarization or a Y-plane polarization and the second combination of polarization and phase uses the other one of the X-plane polarization or the Y-plane polarization, or the first combination of polarization and phase uses one of an in-phase signal component or a quadrature signal component and the second combination of polarization and phase uses the other one of the in-phase signal component or the quadrature signal component.

In a third implementation, alone or in combination with one or more of the first and second implementations, the transmission signal is generated further by modulating the oscillator laser signal with a third signal and a fourth signal, where the oscillator laser signal is modulated with the third signal using a third combination of polarization and phase and with the fourth signal using a fourth combination of polarization and phase.

In a fourth implementation, alone or in combination with one or more of the first through third implementations, the oscillator laser signal is modulated using DP-QPSK modulation.

In a fifth implementation, alone or in combination with one or more of the first through fourth implementations, process 500 includes determining a frequency shift of the reception signal, where the information that is generated further indicates a velocity of the object based on the frequency shift.

Although FIG. 5 shows example blocks of process 500, in some implementations, process 500 includes additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise forms disclosed. Modifications and variations may be made in light of the above disclosure or may be acquired from practice of the implementations. Furthermore, any of the implementations described herein may be combined unless the foregoing disclosure expressly provides a reason that one or more implementations may not be combined.

As used herein, the term “component” is intended to be broadly construed as hardware, firmware, and/or a combination of hardware and software. It will be apparent that systems and/or methods described herein may be implemented in different forms of hardware, firmware, or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be designed to implement the systems and/or methods based on the description herein.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A light detection and ranging (LIDAR) system, comprising:
a transmission signal processor configured to generate a first signal and a second signal,
wherein a first frequency of the first signal is different from a second frequency of the second signal;
multiple optical modulators configured to generate a transmission signal by modulating an oscillator laser signal with the first signal and the second signal,
wherein the oscillator laser signal is to be modulated with the first signal using a first combination of polarization and phase and with the second signal using a second combination of polarization and phase, and
wherein the LIDAR system is configured to transmit the transmission signal and receive a reception signal that is based on a reflection of the transmission signal from an object;
an integrated coherent receiver configured to mix the reception signal with the oscillator laser signal to generate a first detection signal associated with the first signal and a second detection signal associated with the second signal; and
a reception signal processor configured to:
determine a first phase shift of the first signal based on the first detection signal and a second phase shift of the second signal based on the second detection signal; and
generate information that indicates a first distance of the object based on the first phase shift and a second distance of the object based on the second phase shift,
wherein the first distance and the second distance are with respect to different distance resolutions.

2. The LIDAR system of claim 1, wherein the multiple optical modulators comprise Mach-Zehnder modulators.

3. The LIDAR system of claim 1, wherein the multiple optical modulators comprise a first optical modulator to modulate the first signal and a second optical modulator to modulate the second signal.

4. The LIDAR system of claim 1, wherein the first signal is a first tone and the second signal is a second tone.

5. The LIDAR system of claim 1, wherein a wavelength of the second frequency corresponds to a distance resolution that is at least twice a distance resolution that corresponds to a wavelength of the first frequency.

6. The LIDAR system of claim 1, further comprising:
an input component configured to obtain, from a user of the LIDAR system, an input of at least one of a first value for the first frequency of the first signal or a second value for the second frequency of the second signal.

7. The LIDAR system of claim 1, wherein the reception signal processor comprises a first successive approximation register digital phase-locked loop (SAR-DPLL) and a second SAR-DPLL, and
wherein the reception signal processor is configured to determine the first phase shift using the first SAR-DPLL and the second phase shift using the second SAR-DPLL.

8. The LIDAR system of claim 1, wherein the reception signal processor comprises a first XOR logic gate and a second XOR logic gate, and
wherein the reception signal processor is configured to determine the first phase shift using the first XOR logic gate and the second phase shift using the second XOR logic gate.

9. A method, comprising:
generating, by a light detection and ranging (LIDAR) system, a transmission signal by modulating an oscillator laser signal with a first signal and a second signal,
wherein a first frequency of the first signal is different from a second frequency of the second signal, and
wherein the oscillator laser signal is modulated with the first signal using a first combination of polarization and phase and with the second signal using a second combination of polarization and phase;
transmitting, by the LIDAR system, the transmission signal;
receiving, by the LIDAR system, a reception signal that is based on a reflection of the transmission signal from an object;
mixing, by the LIDAR system, the reception signal with the oscillator laser signal to generate a first detection signal associated with the first signal and a second detection signal associated with the second signal;
determining, by the LIDAR system, a first phase shift of the first signal based on the first detection signal and a second phase shift of the second signal based on the second detection signal; and
generating, by the LIDAR system, information that indicates a first distance of the object based on the first phase shift and a second distance of the object based on the second phase shift,
wherein the first distance and the second distance are with respect to different distance resolutions.

10. The method of claim 9, further comprising:
receiving an input of at least one of a first value for the first frequency of the first signal or a second value for the second frequency of the second signal.

11. The method of claim 9, wherein at least one of:
the first combination of polarization and phase uses one of an X-plane polarization or a Y-plane polarization and the second combination of polarization and phase uses the other one of the X-plane polarization or the Y-plane polarization, or
the first combination of polarization and phase uses one of an in-phase signal component or a quadrature signal component and the second combination of polarization and phase uses the other one of the in-phase signal component or the quadrature signal component.

12. The method of claim 9, wherein the transmission signal is generated further by modulating the oscillator laser signal with a third signal and a fourth signal,
wherein the oscillator laser signal is modulated with the third signal using a third combination of polarization and phase and with the fourth signal using a fourth combination of polarization and phase.

13. The method of claim 9, where the oscillator laser signal is modulated using dual polarization quadrature phase shift keying (DP-QPSK) modulation.

14. The method of claim 9, further comprising:
determining a frequency shift of the reception signal,
wherein the information that is generated further indicates a velocity of the object based on the frequency shift.

15. A coherent light detection and ranging (LIDAR) system, comprising:
a transmission signal processor configured to generate a first signal and a second signal,
wherein a first frequency of the first signal is different from a second frequency of the second signal;
an integrated coherent transmitter comprising a first optical modulator and a second optical modulator configured to generate a transmission signal by modulating an oscillator laser signal with the first signal and the second signal,
wherein the oscillator laser signal is to be modulated with the first signal using a first combination of polarization and phase and with the second signal using a second combination of polarization and phase, and
wherein the coherent LIDAR system is configured to transmit the transmission signal and receive a reception signal that is based on a reflection of the transmission signal from an object;
an integrated coherent receiver configured to mix the reception signal with the oscillator laser signal to generate a first detection signal associated with the first signal and a second detection signal associated with the second signal; and
a reception signal processor configured to:
determine a first phase shift of the first signal based on the first detection signal and a second phase shift of the second signal based on the second detection signal; and
determine a first distance of the object based on the first phase shift and a second distance of the object based on the second phase shift,
wherein the first distance and the second distance are with respect to different distance resolutions.

16. The coherent LIDAR system of claim 15, wherein the first distance is with respect to one of a millimeter resolution, a centimeter resolution, or a meter resolution, and the second distance is with respect to a different one of the millimeter resolution, the centimeter resolution, or the meter resolution.

17. The coherent LIDAR system of claim 15, wherein a wavelength of the second frequency corresponds to a distance resolution that is at least twice a distance resolution that corresponds to a wavelength of the first frequency.

18. The coherent LIDAR system of claim 15, further comprising:
an input component configured to obtain, from a user of the coherent LIDAR system, an input of at least one of a first value for the first frequency of the first signal or a second value for the second frequency of the second signal.

19. The coherent LIDAR system of claim 15, where the oscillator laser signal is to be modulated using dual polarization quadrature phase shift keying (DP-QPSK) modulation.

20. The coherent LIDAR system of claim 15, wherein the reception signal processor is a digital signal processor.
